(19) United States
(12) Patent Application Publication
(10) Pub. No.: US 2014/0086532 A1
(43) Pub. Date: Mar. 27, 2014

(54) Optical Coupling Device, Optical Communication System and Method of Manufacture

(71) Applicant: Gert Droesbeke, Saint-Vit (FR)

(72) Inventors: Gert Droesbeke, Saint-Vit (FR); Gnitaboure Yabre, Mainvilliers (FR)

(73) Assignee: FCI, Guyancourt (FR)

(21) Appl. No.: 13/885,817

(22) PCT Filed: Nov. 4, 2011
(86) PCT No.: PCT/EP2011/069447

§ 371 Date: Oct. 29, 2013

(30) Foreign Application Priority Data
Nov. 19, 2010 (IB) PCT/IB2010/003163

(51) Int. Cl. G02B 6/42

(52) U.S. Cl. CPC G02B 6/4239; G02B 6/4257
USPC 385/39; 156/305

(57) ABSTRACT

An optical coupling device includes: a first face facing a support of the optical coupling device, this support having a reception face facing upwards and; a cavity mouthing to the first face, and receiving glue to fix the optical coupling device to the support. The cavity is surrounded by a wall including a second face facing at least partly upwards.

### FIELD OF THE INVENTION

The instant invention relates to optical coupling devices, optical communication systems comprising such optical coupling devices, and their method of manufacture.

### BACKGROUND OF THE INVENTION

Most communication systems involve a number of system-cards. Such cards are usually manufactured as so-called printed circuit boards (PCBs). Because of the ever increasing requirements in data rates, due for example to the Internet, the limits of using electrical communications are being reached. It has become difficult to guarantee good signal integrity over the electrical lines.

To respond to this bandwidth demand, high speed systems are now being built with optical layers (optical fibre or planar waveguide) incorporated in replacement of the electrically-conducting metal. Indeed, light does not suffer from the same limitations as electricity.

Optical coupling devices are usually used to interconnect an optical layer of a PCB, or so-called optical circuit board (OCB), with an external optical device. In order to ensure efficient transfer of light through the optical coupling device, a very precise positioning of it along a vertical direction with respect to the circuit board is necessary. Then, a fixation part of the optical coupling device is glued to a fixation surface of the optical circuit board.

It is required to improve the fixation of the optical coupling devices to the optical circuit boards.

### SUMMARY OF THE INVENTION

It is provided an optical coupling device for an optical communication system. The optical coupling device comprises a first face, which is to face a support of the optical coupling device. This support has a reception face facing upwards and adapted to receive the optical coupling device.

The optical coupling device further comprises a cavity mouthing to the first face, and adapted to receive glue to fix the optical coupling device to the support.

The cavity is surrounded by a wall comprising a second face facing at least partly upwards.

With these features, cured glue will act as an anchor, further contributing to the prevention of the tearing away of the coupling device.

In some embodiments, one might also use one or more of the features defined in the dependant claims.

According to another aspect, it is provided an optical coupling device for an optical communication system. The optical coupling device comprises:

a bottom face adapted to face a support of the optical coupling device, and

a top face opposed to the bottom face.

A through hole extends between said top face and said bottom face. The through hole can receive glue to fix the optical coupling device to the support.

This allows glue to be dispensed from over the optical coupling device rather than from the side thereof, which is much easier to perform, and allows to glue in other places than only the periphery of the optical coupling device.

In some embodiments, one might also use one or more of the features defined in the dependant claims.

### BRIEF DESCRIPTION OF THE DRAWINGS

Other characteristics and advantages of the invention will readily appear from the following description of four of its embodiments, provided as non-limitative examples, and of the accompanying drawings.

On the drawings:

FIG. 1 is a partial perspective top view of an optical system,

FIG. 2 is perspective view of the bottom face of an optical coupling device,

FIG. 3 is a partial sectional view along line III-III of FIG. 1 for a first circuit board,

FIG. 4 is a view partially similar to FIG. 3 for a second embodiment,

FIG. 5 is a view similar to FIG. 4 for a third embodiment,

FIG. 6 is a partial top view of the third embodiment, and

FIG. 7 is a view similar to FIG. 4 for a fourth embodiment.

On the different Figures, the same reference signs designate like or similar elements.

### DETAILED DESCRIPTION

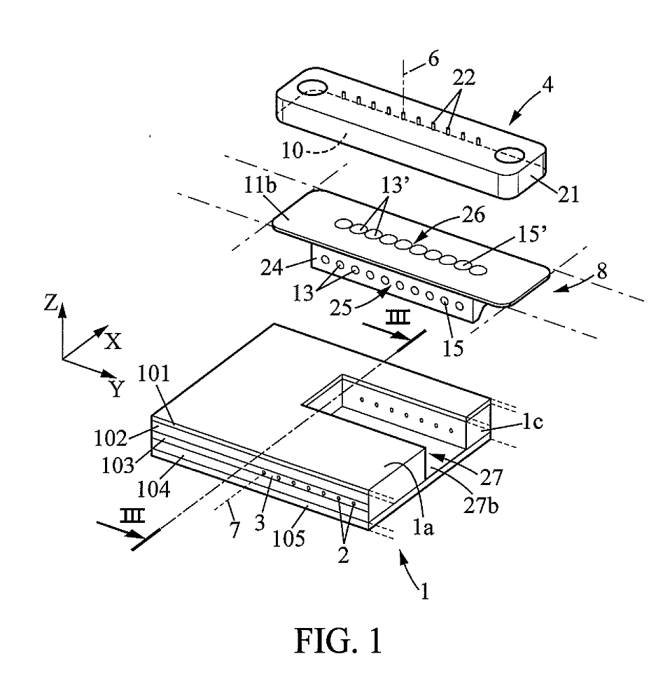

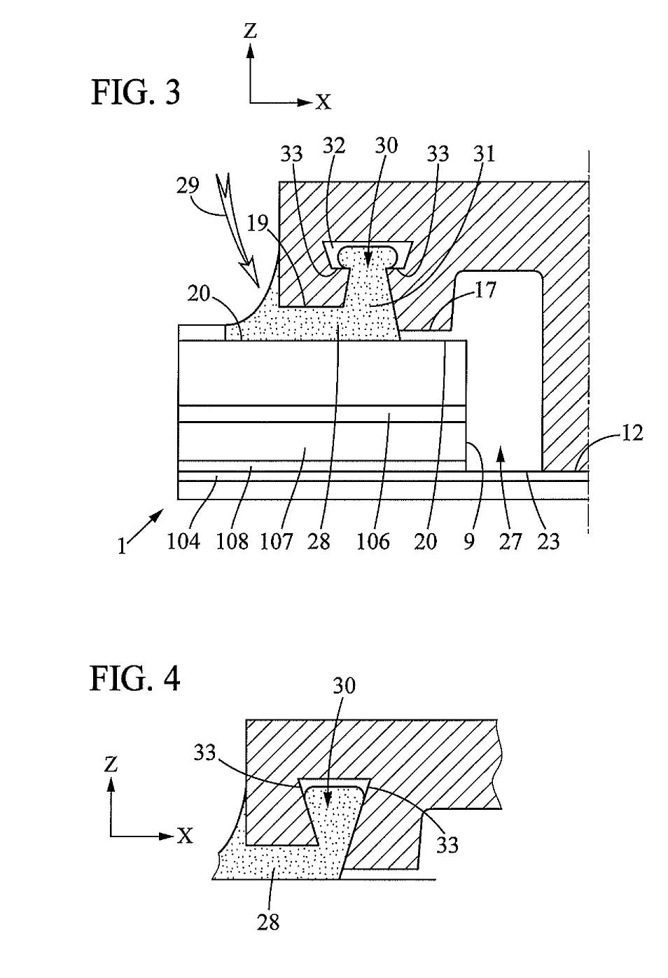

FIG. 1 partially shows a hybrid or full optical PCB 1 for example a backplane, which is a layer stack comprising a plurality of layers. In particular, this layer stack 1 comprises, from top to bottom, a copper layer 101, a pre-preg layer 102, an optical layer 103, and further copper 104 and pre-preg 105 layers. The optical layer 103 itself comprises a first top cladding layer 106, a second transmission optical layer 107 below the first top cladding layer 106, and a third bottom cladding layer 108 below the second transmission optical layer 107 (see FIG. 3).

The terms “top”, “bottom”, “up”, “down” or the like are given in reference to the direction Z, normal to the top surface 1a of the PCB, and pointing toward a mating optical device 4 to be optically coupled to the PCB. The top surface of the PCB extends parallel to an X-Y plane, with X and Y being artificially defined. For example, X corresponds to the direction of propagation of light in the layer 107 and Y to the direction transverse thereto.

The optical layer 107 of the layer stack 1 is made of a plurality of tubes 2 integrated or embedded in a body 3 having a lower refractive index than the tubes 2. Thus, the tubes 2 and the body 3 constitute respectively the cores and the cladding of waveguides. Embedded waveguides may be polymer waveguides, glass sheet waveguides or waveguides obtained by embedded fibre technology, or the like.

It will be understood that a part of the PCB is removed from FIG. 1 to ease representation, and that what appears as a face 1c is in reality not a face but is internal to the PCB 1.

As can be seen on FIG. 1, a cut-out 27 is formed in the PCB 1. In particular, the cut-out 27 is shaped with a very simple form of a right parallelepiped. The cut-out is defined by straight walls. The cut-out can also have a plane bottom 27b, as shown.

The wall where the tubes 2 mouth into the cut-out defines an optical interface of the PCB. Namely, all cores 2 mouth into the cut-out 27 to define the optical interface 9 of the PCB (FIG. 3). This optical interface 9 comprises discrete light transmission regions arranged as an array. The spacing of transmission regions along the direction Y might be constant or not, depending on the requirements. For example, in the present drawing, the spacing between neighbour transmission regions is set constant to 250 μm.

Optical signals, transferred to or from a mating optical device 4, such as an optical device or opto-electrical device or an other PCB, are provided over a first optical path 6 to/from the cores 2 of the layer stack 1, which core 2 provides a second optical path 7 for the optical signal parallel to the X-Y plane. In the present example, the optical device 4 can for example comprise a mechanical-transfer ferrule (“MT-ferrule”) comprising a high precision sleeve 21 in which ends of optical fibers 22 extend in precisely defined relative locations. The mating optical device 4 thus has an optical interface 10 defined as the set of optic fibre ends directed toward the PCB. In the present drawing, this interface extends parallel to the X-Y plane.

The optical interface 10 of the mating connector has the same number of transmission regions as the optical interface 9 of the PCB. Each transmission region of the optical interface 10 of the mating optical device corresponds to a respective transmission region of the optical interface 9 of the PCB. This means that transmission regions are associated two by two and that light normally exited through the transmission region of one of the interfaces is to be transmitted to the corresponding transmission region of the other interface.

The printed circuit board 1 further comprises a Z-reference. The Z-reference is a part of the printed circuit board the location of which along the Z direction is precisely known with respect to the optical interface 9. For example, it corresponds to the bottom of the bottom cladding layer (or rather to the coinciding top 23 (see FIG. 3) of the underlying copper layer 104). However, other locations are possible, such as the top of the top cladding layer, for example.

In order to achieve an optimal optical coupling between the first and second optical paths, that are perpendicular to each other for the optical system here, an optical coupling device 8 is provided for alignment purposes. In the present example, the optical coupling device 8 is provided as a single unitary component, although this is not necessarily always the case. Only the central part of the optical coupling device, which is used for optical coupling, is visible on FIG. 1.

The coupling device 8 is, for example, a unitary piece manufactured by moulding a translucent suitable material. The optical coupling device 8 comprises a first face 24 defining a first optical interface 25 which is to be put in optical coupling with the optical interface 9 of the PCB. The first optical interface 25 has transmission regions 13 which are to be placed opposite in free space (sometimes through a translucent coupling medium such as air or a suitable glue) a corresponding transmission region of the interface of the PCB. Hence, the arrangement of the first optical interface 25 directly derives from that 9 of the printed circuit board, and it will not be described in further details here.

The optical coupling device 8 comprises a second face 11b which, in the present case, extends normal to the first face, i.e. extends parallel to the X-Y plane. It defines a second optical interface 26 which is to be put in optical coupling with the optical interface of the mating optical device 4. The second optical interface 26 has transmission regions 13′ which are to be placed opposite (sometimes through a translucent coupling medium such as air or a suitable glue) a corresponding transmission region of the interface of the mating optical device 4. Hence, the arrangement of the second optical interface 26 directly derives from that of the mating optical device 4, and it will not be described in further details here.

An optical path is defined between the first and second interfaces 25, 26 of the coupling device 8. Namely, diverging light entering the coupling device 8 at its first interface 25, coming from the interface of the printed circuit board 1 will be propagated through the coupling device 8 to the second interface 26 as a substantially collimated light beam, and will be focussed into the interface of the mating optical device 4. Light propagates in the opposite direction in a similar way.

In particular, each transmission region of each interface of the coupling device 8 can be provided with a light beam forming structure 15, 15′ such as a lens. The lenses 15 optimise the optical coupling of the optical signals of the cores 2 to/from the coupling device 8. The lenses 15′ optimise the optical coupling of the optical signals of the ferrule 4 to/from the coupling device 8.

Since lenses 15 and 15′ focus the optical signals at the entry of each core 2 and respectively at the entry of each optical fibre 22, the manufacture tolerance of the coupling device 8, the ferrule 4 and the layer stack 1 are increased in comparison with an optical coupling system without lenses.

As shown in the present example, the lenses 15, 15′ may form an integral part of the coupling device 8. They are located at the first and second interfaces. They could be of the Fresnel-type or of the aspheric type, for example. It will be appreciated that, for each interface, all lenses of the interface could be performed identical.

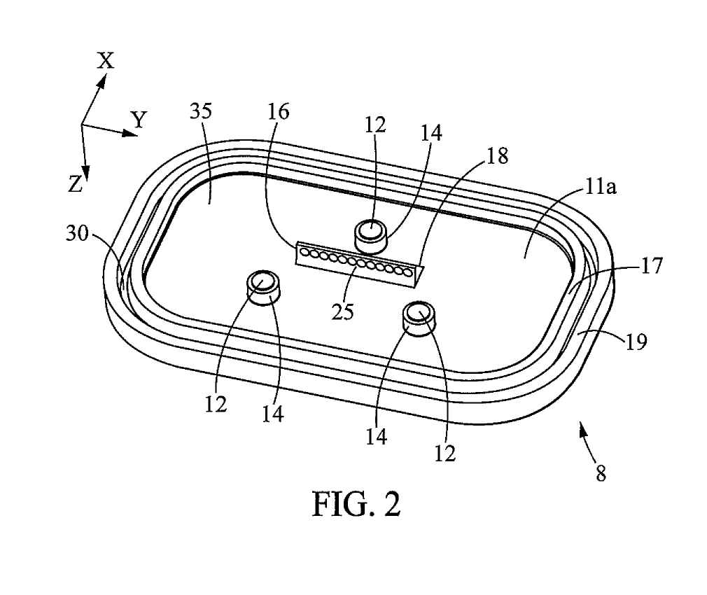

FIG. 2 now shows in more details the bottom face of the coupling device 8. (It is now shown entirely). The coupling device 8 is provided as a thin plate having a first (bottom) face 11a and an opposite parallel second (top) face 11b (FIG. 1). A body 16 projects from the bottom face 11a downwards, rather centrally. This body carries the optical interface 25, as well as a mirror 18 used to deflect light from the X direction to the Z direction.

Further, the optical coupling device 8 is provided with Z-reference parts 12. Z-reference parts 12 are parts of the optical coupling device 8, the location of which along the direction Z is precisely known with respect to the first optical interface 25. These parts are for example surfaces extending parallel to the X-Y surface. For example, three such parts can be provided on three feet 14 which project from the face 11a. These feet can be provided unaligned, and of the same length, so that the three Z-reference parts 12 precisely define a plane.

The optical coupling device 8 further comprises fixation parts. These fixation parts are used to fix the optical coupling device 8 to the printed circuit board 1. The fixation parts are for example provided at the periphery of the optical coupling device 8, such as in the present first embodiment. For example, a first fixation part is a peripheral ridge 17 which extends continuously around the whole periphery of the device. Further, a second fixation part is provided as a second peripheral ridge 19, which extends continuously around the whole periphery of the device. The second peripheral ridge also surrounds the first peripheral ridge 17. Thus, the second peripheral ridge 19 is an outer fixation part, while the first peripheral ridge 17 is an inner fixation part. Hence, the first peripheral ridge 17 is located between the second peripheral ridge 19 and the body 16.

The fixation parts 17, 19 project from the face 11a of the optical coupling device.

As can be seen in FIG. 3, the optical coupling device will be placed over the cut-out 27 of the printed circuit board 1 so that the Z-reference parts 12 will cooperate with the Z-reference of the printed circuit board, so as to precisely define the position of the optical coupling device 8 with respect to the Z-reference of the printed circuit board along the Z axis. For example, the Z-reference parts 12 are simply laid on the Z-reference 23 of the printed circuit board 1. However, other ways to precisely define the location of the optical coupling device 8 along the Z direction with respect to a Z-reference of the printed circuit board exist.

In theory, in this position, the optical coupling device and the printed circuit board are so positioned with respect to one another along the direction Z, that an efficient optical coupling occurs between the interface 9 (out of the plane of FIG. 3) of the printed circuit board and the optical interface 25 of the optical coupling device (not visible on this drawing). This is due to the precisely known relative positioning along the direction Z of:

the interface 9 of the circuit board with the Z-reference 23 by construction of the circuit board,

the Z-reference 23 with the Z-reference part 12 of the optical coupling device 8 by co-operation, and

the Z-reference part 12 with the optical interface 25, by construction of the coupling device.

If necessary, X-Y reference means (not shown) are used to carefully place the coupling device with respect to the circuit board in the X-Y plane.

The Z axis is oriented in a direction out of the main plane of the circuit board, toward the mating optical device 4. This is the direction of light exiting the circuit board.

The fixation surface 20 of the printed circuit board is used to cooperate with the fixation parts 17, 18 of the optical coupling device 8 to fix the optical coupling device 8 to the circuit board 1. For example, the fixation surface 20 corresponds to the accessible top face 1a of the printed circuit board, either being for example the top face of the copper layer 101 or that of the pre-preg layer 102 if the copper layer 101 has been removed in this area.

When the optical coupling device 8 is placed on the printed circuit board, the inner and outer fixation parts 17, 19 are spaced apart from the surface 20, to enable the Z-reference part 12 to lay on the Z-reference 23 of the circuit board.

Further, the heights of these fixation parts differ from one another. In the present embodiment, they may differ by at least 50 micrometers.

In particular, the first (inner) fixation part 17 is closer to the fixation surface 20 than the second (outer) fixation part 19.

Once the optical coupling device is positioned, glue is made to flow from the periphery of the coupling device, for example using a syringe along the arrow 29. Glue 28 will flow between the bottom surface of the first fixation part 17 and the fixation surface 20 of the circuit board, directly opposed thereto. Fixation will occur between these two surfaces.

The coupling device is provided with a recess 30 located between the first and second fixation parts. In the present example where the first and second fixation parts are peripheral ridges running all along the periphery of the coupling device, the recess 30 can be provided as a groove also running all along the periphery of the coupling device (see FIG. 2). The recess 30 will absorb glue flown between the coupling device and the circuit board.

As can be seen on FIG. 3, the recess 30 comprises two distinct portions 31, 32. The first portion 31 extends from the bottom of the optical coupling device upwards along direction Z and mouth into the second portion 32. In particular, the second portion 32 is broader, along direction X, than the first portion 31, so that the wall which defines and surrounds the recess 30 has a face 33 facing upward. In the present example, the face 33 lies in the X-Y plane and has its normal oriented along the direction Z.

When the glue 28 flows in the recess 30, it will flow in the second portion 32. Once cured, the glue 28 hardens, so that it will mechanically cooperate with the face 33 of the optical coupling device in case removal forces are exerted along the axis Z which would tend to remove the optical coupling device from the circuit board 1. The glue will act as an anchor means to improve the retention of the optical coupling device to the circuit board 1.

FIG. 4 now shows partially a second embodiment of the invention. When compared to the first embodiment of FIG. 3, the shape of the recess 30 differs. In particular, the recess does not have the first and second portions 31, 32 of the first embodiment. However, instead of having the recess 31 narrowing along direction Z as on FIG. 3, the recess now broadens along direction Z so that the recess 30 comprises faces 33 which face only partly upwards. Hence, a face 33 is considered to face at least partly upwards when the projection of its normal on the Z axis is directed upwards. A suitable angle for the faces 33 is considered to be of at least 15 degrees with respect to the Y-Z plane.

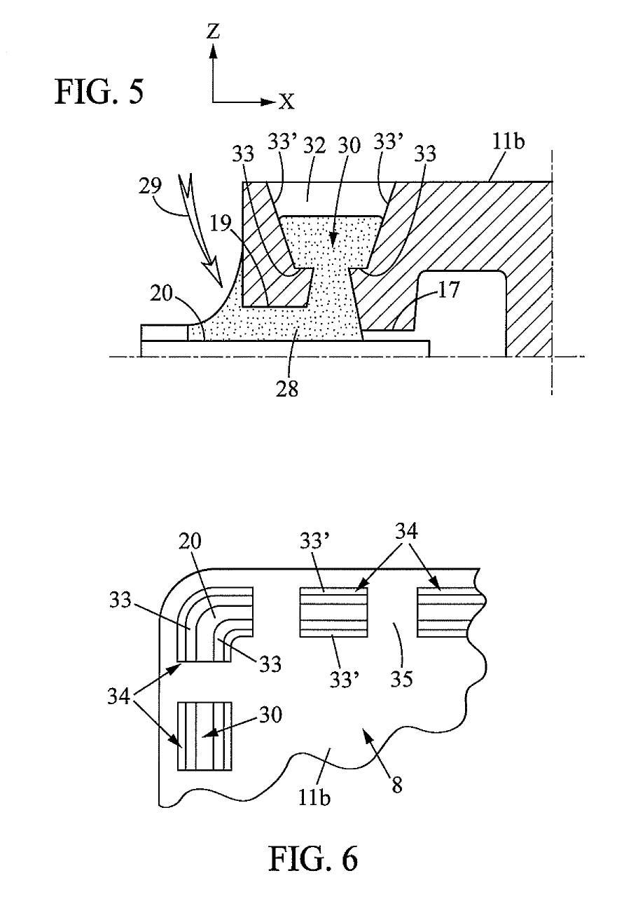

FIG. 5 now shows a third embodiment of the invention. The embodiment of FIG. 5 is similar to the one of FIG. 3, with the difference that the second portion 32 extends up to the top face of the optical coupling device, as shown. Hence, the optical coupling device 8 is provided with a through hole extending from its top face 11b to its bottom face. The second portion has a geometry similar to the second portion of the first embodiment, with the top facing faces 33, as well as further slanted surfaces 33′ extending from the face 33 to the top face 11b. These slanted faces 33′ may also face partly upwards, as shown.

FIG. 6 partially shows a top view of the optical coupling device 8 according to the embodiment of FIG. 5.

It is only in some local areas 34 that the recess 30 is performed as a through hole. In intermediate regions 35, intermediate between two local areas 34, the cross-section of the recess 30 may be as shown on FIG. 3, for example or there might not even be any recess in these locations. However, such recesses allow glue to flow uniformly along the periphery of the optical coupling device 8. The location of the various local areas 34 can be as shown on FIG. 6. However, to ease the dispensing of the glue, there may not be any such local area 34 in the corners of the optical coupling device, as shown on FIG. 6.

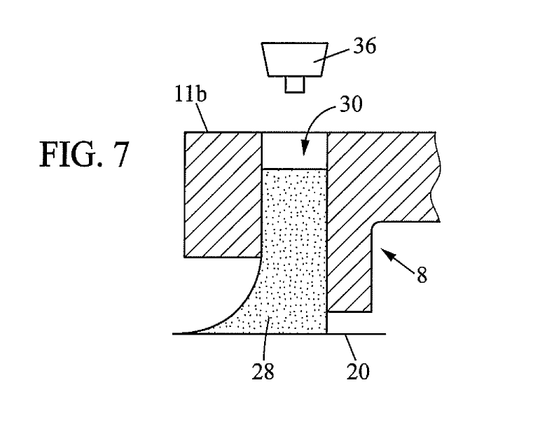

When the recess 30 is provided as a through hole, such as shown on FIGS. 5 and 6, glue may be dispensed through the optical coupling device, from its top face 11b, as shown on FIG. 7, rather than from the side (arrow 29 of FIGS. 3 to 5). A glue-dispensing nozzle 36 is schematically shown on FIG. 7. Dispensing glue from the top rather than from the periphery may be advantageous, because it means that glue needs not necessarily be dispensed only at the periphery of the optical coupling device, but may be dispensed in other locations. In particular, glue may be dispensed closer to the central region comprising the optically relevant components, which would enable to provide the fixation in a more strategic location. Of course, a glue barrier may have to be finely defined to prevent any flow of glue from interfering with the transfer of optical signals at the optical coupling device.

As shown on FIG. 7, according to this embodiment of the invention, the recess 30 needs not necessarily exhibit any upward facing face. For example, the walls defining the recess 30 may extend straight along the Z axis, i.e. normal to the reception face of the PCB1.

1. An optical coupling device for an optical communication system, said optical coupling device comprising:
a first face adapted to face a support of the optical coupling device, said support having a reception face facing upwards and adapted to receive the optical coupling device,
a cavity mouthing to the first face, and adapted to receive glue to fix the optical coupling device to the support, wherein the cavity is surrounded by a wall comprising a second face facing at least partly upwards.

2. Optical coupling device according to claim 1, having a central region for optical coupling, and wherein the cavity includes a peripheral groove surrounding the central region.

3. Optical coupling device according to claim 1, wherein the cavity has a narrow portion and a broad portion, the narrow portion being closer to the first face than the broad portion.

4. Optical coupling device according to claim 1, having an outer top face opposed to the first face, and adapted to face an optical component to be optically coupled to the support, wherein the cavity comprises at least one through hole extending between the outer top face and the first face.

5. Optical coupling device according to claim 1 comprising a top face and wherein the second face of the wall is normal oriented in respect to the top face.

6. An optical coupling device for an optical communication system, said optical coupling device comprising:
a bottom face adapted to face a support of the optical coupling device,
a top face opposed to the bottom face,
a through hole extending between said top face and said bottom face, and adapted to receive glue to fix the optical coupling device to the support.

7. Optical coupling device according to claim 6, having a central region for optical coupling, further having a peripheral groove surrounding the central region, said peripheral groove mouthing at least to said through hole and to another through hole extending between said top face and said bottom face, said another through hole being also adapted to receive glue to fix the optical coupling device to the support.

8. Optical coupling device according to claim 6, wherein said support has a reception face facing topwards and adapted to receive the optical coupling device, wherein the surrounding walls of said through hole extend normal to said reception face.

9. Optical communication system comprising:
an optical coupling device according to claim 1,
an optical circuit board, forming a support having a reception face facing upwards and adapted to receive said optical coupling device.

10. A method of manufacturing an optical communication system comprising:
providing an optical circuit board having a reception face,
placing an optical coupling device over the optical circuit board, the optical coupling device comprising:
a bottom face placed facing the reception face,
a top face opposed to the bottom face,
a through hole extending between said top face and said bottom face,
dispensing liquid curable glue from over the top face through the through hole to fix the optical coupling device to the optical circuit board.
